(19) United States
(12) Patent Application Publication
(10) Pub. No.: US 2010/0128352 A1
(43) Pub. Date: May 27, 2010

(54) LIGHT-GUIDING PLATE AND MANUFACTURING METHOD THEREOF

(75) Inventors: Chih Wei Huang, Taipei (TW); Chi Feng Lee, Taipei (TW); Chyi Kun Lin, Taipei (TW); Chih Ho Hsieh, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTEK COMPUTER INC., Taipei (TW)

(21) Appl. No.: 12/622,790

(22) Filed: Nov. 20, 2009

(30) Foreign Application Priority Data
Nov. 21, 2008 (TW) 097145105

(51) Int. Cl. G02B 6/00; B05D 5/06; B32B 37/00

(52) U.S. Cl. 359/613; 427/162; 156/60

(57) ABSTRACT

The invention discloses a light-guiding plate and a manufacturing method thereof. The light-guiding plate includes a light-guiding substrate, a first shielding layer, and a second shielding layer. The light-guiding substrate has a first surface and a second surface opposite to the first surface. The first shielding layer is disposed on the first surface and includes a first light-transmitting portion. The second shielding layer is disposed on the second surface and includes a second light-transmitting portion. Thereby, light emitted from a light source could pass through the first light-transmitting portion, the light-guiding substrate, and the second light-transmitting portion, so that a light-halo phenomenon does not occur on the light-guiding plate.

### BACKGROUND OF THE INVENTION

1. Field of the Invention

The invention relates to a light-guiding plate and a manufacturing method thereof and, more particularly, to a light-guiding plate and a manufacturing method capable of overcoming the light-halo phenomenon.

2. Description of the Prior Art

Please refer to FIG. 1. FIG. 1 is a sectional view illustrating a light-guiding plate and a light source in prior art. According to the embodiment, the light-guiding plate 1 comprises a light-guiding substrate 12, a light-color ink layer 14 and a dark-color ink layer 16. The light-color ink layer 14 is coated on the light-guiding substrate 12, and the dark-color layer 16 is further coated on the light-color ink layer 14. There is a hollow region among the light-color ink layer 14 and the dark-color ink layer 16 to form a light-transmitting region 18. When the light source 2 is disposed below the light-guiding plate 1, a light emitted by the light source 2 may pass through the light-transmitting region 18 and the light-guiding substrate 12 (the pattern of the light is shown in an arrowed dash line). As light-guiding substrate usually has a considerable thickness, the light scatters while passing through the light-guiding substrate 12. Therefore, when the light is projected out through the light-guiding substrate 12, the projecting region (shown as the mark L in FIG. 1) is obviously larger than the intersectional surface of the light-transmitting region 18 so that the light-halo phenomenon is induced.

When there is a pattern with some intensive stripes (e.g. small-sized letters) displayed on the light-transmitting region 18, the stripes of the pattern can not be revealed, and even the instructing function is lost because of the light-halo phenomenon. In the trend of minimization of the electronic appliances, the light-guiding plate for instructing function is tending to have a smaller size, so does the instructing pattern thereon, which makes the light-halo phenomenon more irretrievable.

### SUMMARY OF THE INVENTION

A scope of the invention is to provide a light-guiding plate capable of overcoming the light-halo phenomenon.

Another scope of the invention is to provide a manufacturing method of a light-guiding plate capable of overcoming the light-halo phenomenon.

According to an embodiment, the light-guiding plate comprises a light-guiding substrate, a first shielding layer and a second shielding layer. The light-guiding substrate has a first surface and a second surface opposite to the first surface. The first shielding layer is disposed on the first surface and comprises a first light-transmitting portion. The second shielding layer is disposed on the second surface and comprises a second light-transmitting portion. Accordingly, a light emitted from a light source is capable of passing through the first light-transmitting portion, the light-guiding substrate and the second light-transmitting portion, so that a light-halo does not occur on the light-guiding plate while the light is projected out through the light-guiding substrate.

The manufacturing method of the light-guiding plate of the invention comprises steps of: preparing a light-guiding substrate with a first surface and a second surface opposite to the first surface; forming a first shielding layer on the first surface, and the first shielding layer comprising a first light-transmitting portion; and forming a second shielding layer on the second surface, and the second shielding layer comprising a second light-transmitting portion. Accordingly, the light-guiding plate of the invention is formed.

The advantage and spirit of the invention may be understood by the following recitations together with the appended drawings.

### BRIEF DESCRIPTION OF THE APPENDED DRAWINGS

FIG. 1 is a sectional diagram illustrating a light-guiding plate and a light source in prior art.

FIG. 2 is a sectional diagram illustrating a light-guiding plate and a light source according to an embodiment of the invention.

FIG. 3 is a flowchart of manufacturing the light-guiding plate 3 shown in FIG. 2.

FIG. 4 is a flowchart of manufacturing a light-guiding plate according to another embodiment of the invention.

FIG. 5 is a schematic diagram illustrating the light-guiding plate 5 manufactured in FIG. 4.

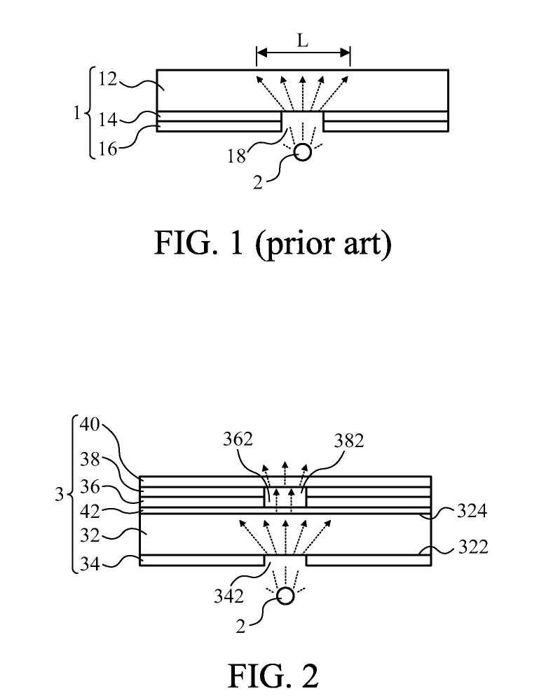

### DETAILED DESCRIPTION OF THE INVENTION

Please refer to FIG. 2. FIG. 2 is a sectional diagram illustrating a light-guiding plate and a light source according to an embodiment of the invention. According to the embodiment, the light-guiding plate 3 comprises a light-guiding substrate 32, a first shielding layer 34, a second shielding layer 36, a background layer 38, a transparent protecting layer 40 and an adhering layer 42. The light-guiding substrate 32 has a first surface 322 and a second surface 324 opposite to the first surface 322. The first shielding layer 34 is disposed on the first surface 322, and the first shielding layer 34 comprises a first light-transmitting portion 342. In the embodiment, the first shielding layer 34 can be, for example, a dark-color ink layer, which can be formed on the first surface 322 in a way of coating (e.g. printing). The first light-transmitting portion 342 of the first shielding layer 34 exposes a part of the light-guiding substrate 32.

The second shielding layer 36 is disposed on the second surface 324 by way of the adhering layer 42. The second shielding layer 36 comprises a second light-transmitting portion 362. The background layer 38 is disposed on the second shielding layer 36. To be exactly in the embodiment, the background layer 38 is disposed on one surface of the second shielding layer 36 distanced from the light-guiding substrate 32. The background layer 38 further comprises a third light-transmitting portion 382. The transparent protecting layer 40 is disposed on the second shielding layer 36. To be exactly in the embodiment, the transparent protecting layer 40 is disposed on one surface of the background layer 38 distanced from the light-guiding substrate 32; in other words, the background layer 38 is disposed between the transparent protecting layer 40 and the second shielding layer 36. In the embodiment, the transparent protecting layer 40 is a transparent plastic sheet. The background layer 38 can be, for example, a light-color ink layer, which can be formed in a way of coating onto one surface of the transparent protecting layer 40 which the surface faces the light-guiding substrate 32. On the other hand, the region without light-color ink is the third light-transmitting portion 382.

In said structure, the second shielding layer 36 can be a dark-color ink layer as well, which can be, for example, formed in a way of coating onto one surface of the background layer 38 which the surface faces the light-guiding substrate 32. The second light-transmitting portion 362 is adjacent to the third light-transmitting portion 382. A projection of the second light-transmitting portion 362 upon the second surface 324 is identical to a projection of the first light-transmitting portion 342 upon the second surface 324. In the embodiment, the first light-transmitting portion 342 and the adjacent second light-transmitting portion 362 are disposed on one side of the light-guiding substrate 32, while the third light-transmitting portion 382 is disposed on the other side of the light-guiding substrate 32. The statement of “A projection of the second light-transmitting portion 362 upon the second surface 324 is identical to a projection of the first light-transmitting portion 342 upon the second surface 324” is provided as an example. In other embodiment, the projections of the second light-transmitting portion 362 and the first light-transmitting portion 342 are not limited to be identical or mutually covered. The second light-transmitting portion 362 needs only to correspond the first light-transmitting portion 342, for allowing the light to pass through the first light-transmitting portion 342 and the light-guiding substrate 32, and then to be emitted from the second light-transmitting portion 362.

When the light source 2 is disposed below the first light-transmitting portion 342, the light (the pattern of the light is shown in an arrowed dash line) emitted by the light source 2 can pass through the first light-transmitting portion 342, the light-guiding substrate 32, the adhering layer 42, the second light-transmitting portion 362, the third light-transmitting portion 382 and the transparent protecting layer 40. The thickness of the light-guiding substrate 32 in the embodiment is around 0.30 mm to 0.40 mm, so that the light may have a chance to scatter while going through the light-guiding substrate 32. However, with the shielding of the second shielding layer 36, the light may pass only through the second light-transmitting portion 362, so that it alleviates the considerate light-halo phenomenon in prior art. In addition, the transparent protecting layer 40 in the embodiment may also induce the scattering effect, which the scattering effect is limited to a certain degree because the thickness of the transparent protecting layer 40 is around 0.125 mm only.

Additionally, the transparent protecting layer 40, mainly used for protecting the second shielding layer 36 and the background layer 38, is not a must in the invention. The background layer 38, mainly used for generating a background color on the light-guiding plate 3, is not a must in the invention either. The adhering layer 42 is mainly used for adhering the second shielding layer 36, isolated from another object (transparent protecting layer 40 in the embodiment), to the second surface 324 of the light-guiding substrate 32. That is to say, the adhering layer 42 may be omitted when the second shielding layer 36 is directly formed on the second surface 324. In summary, whether to implant the adhering layer 42 or not depends on the manufacturing procedures. On the other hand, whether to implant the transparent protecting layer 40 and the background layer 38 or not depends on the demanding of the design.

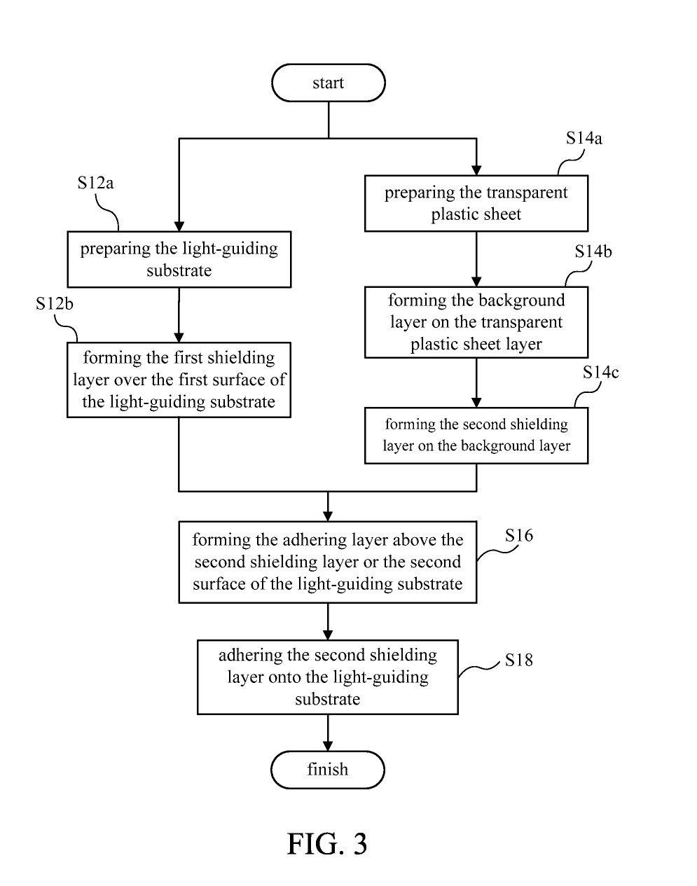

Please refer to FIG. 3. FIG. 3 is a flowchart of manufacturing the light-guiding plate 3 shown in FIG. 2. Firstly, step S12a is executed to prepare the light-guiding substrate 32. Afterward, step S12b is executed to form the first shielding layer 34 on the first surface 322 of the light-guiding substrate 32. The first shielding layer 34 can be, for example, a dark-color ink layer, which can be formed on the first surface 322 in a way of coating (e.g. printing). However, the first shielding layer 34 of the invention is not limited to the embodiment, but the first shielding layer 34 may have several alternative forms. For example, the first shielding layer 34 can be an opaque plate attached on the first surface 322, which the opaque plate is punched to form a hole served as the first light-transmitting portion 342. In other case, the first shielding layer 34 can be an object (e.g. plastic membrane), which is printed with dark-color ink and attached on the first surface 322.

Besides, step S14a is executed to prepare the transparent plastic sheet (i.e. transparent protecting layer 40). Afterward, step S14b is executed to form the background layer 38 on the transparent plastic sheet layer. Afterward, step S14c is executed to form the second shielding layer 36 on the background layer 38. The background layer 38 can be, for example, a light-color ink layer, which can be formed in a way of coating onto the transparent plastic sheet, and the second shielding layer 36 can be a dark-color ink layer which is further printed on the light-color ink layer (i.e. background layer 38). However, the second shielding layer 36 and the background layer 38 of the invention are not limited to the embodiment, but have several alternative forms. For example, the background layer 38 and the second shielding layer 36 may respectively be formed by attaching an opaque plate onto a transparent plastic sheet. In other case, the second shielding layer 36 can be an opaque plate, where the light-color ink treated as the background layer 38 is further printed. At last, the background layer 38 is attached to the transparent plastic sheet for forming said structure. In addition, when the light-color ink is printed, the third light-transmitting portion 382 is formed at the same time (the region without ink). When the dark-color ink is printed, the second light-transmitting portion 362 is formed at the same time (the region without ink).

Afterward, step S16 is executed to form the adhering layer 42 on the second shielding layer 36 or the second surface 324 of the light-guiding substrate 32. The adhering layer 42 is a gum formed by spreading adhesive or a double-sided tape. In addition, even though the adhesive is pervious to light in some degree, it can still form a hollow region corresponding to the second light-transmitting portion 362 while forming the adhering layer 42, for a better light transmittance. Finally, step S18 is executed to utilize the adhering layer 42 to adhere the second shielding layer 36 onto the second surface 324 of the light-guiding substrate 32. Accordingly, the light-guiding plate 3 in FIG. 2 is completed.

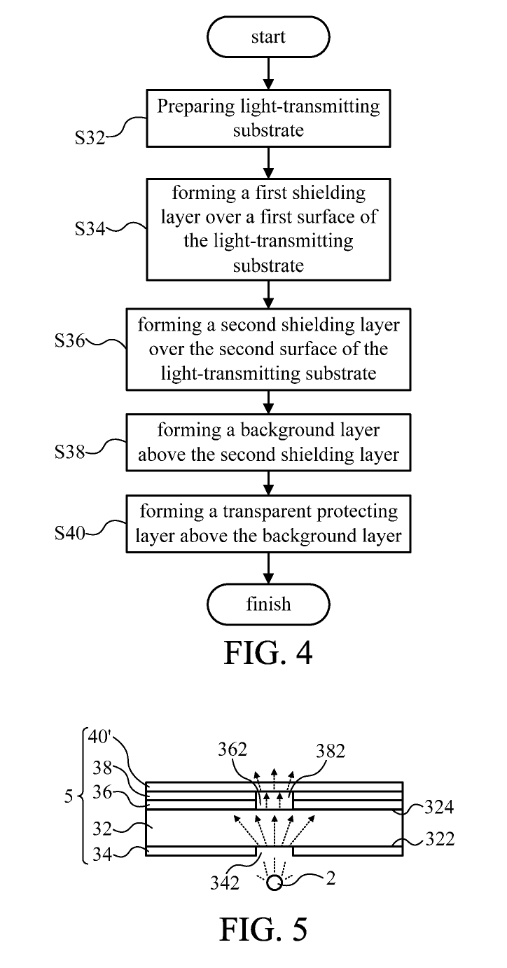

Please refer to FIG. 4 and FIG. 5. FIG. 4 is a flowchart of manufacturing a light-guiding plate according to another embodiment of the invention. FIG. 5 is a schematic diagram illustrating the light-guiding plate 5 manufactured in FIG. 4. Firstly, step S32 is executed to prepare a light-guiding substrate 32. Afterward, step S34 is executed to form a first shielding layer 34 on a first surface 322 of the light-guiding substrate 32. Afterward, step S36 is executed to form a second shielding layer 36 on a second surface 324 of the light-guiding substrate 32. Afterward, step S38 is executed to form a background layer 38 on the second shielding layer 36. Finally, step S40 is executed to form a transparent protecting layer 40′ on the background layer 38. Accordingly, the light-guiding plate 5 in FIG. 5 is completed.

The difference between the light-guiding plate 5 in FIG. 5 and the light-guiding plate 3 in FIG. 2 is that the light-guiding plate 5 does not need the adhering layer 42 for adhering the second shielding layer 36 and the light-guiding substrate 32. Besides, the transparent protecting layer 40′ of the light-guiding plate 5 can be formed on the second shielding layer 36 in a way of coating, not limited to a firm sheet (e.g. the transparent plastic sheet of the light-guiding plate 3). Said corresponding descriptions about the light-guiding substrate 32, the first shielding layer 34, the second shielding layer 36, the background layer 38 and the transparent protecting layer 40 in the light-guiding plate 3 may be suitable in the light-guiding plate 5, and are not mentioned repeatedly.

In addition, the light-transmitting portions in said embodiments are not limited to be transparent, and not necessary to be entirely hollow. For example, the second shielding layer 36 can be produced in a way of coating the dark-color ink on a transparent thin sheet according to a pattern. At the same time, the second light-transmitting portion 362 is the region without coating the dark-color ink on the transparent thin sheet. Otherwise, the light-color ink layer (background layer 38) usually has a transmittance at certain degree. Therefore, the background layer 38 of the light-guiding plate 3 in FIG. 3 may be coated onto the transparent protecting layer 40 entirely, and the region upon the background layer 38 corresponding to the second light-transmitting portion 362 of the second shielding layer 36 is defined as the third light-transmitting portion 382.

In summary, the light-guiding of the invention utilizes the first shielding layer and the second shielding layer to shield the light emitted by the light source layer by layer. It prevents the light-scattering effect caused by the light-guiding substrate, and further allows the light-transmitting portion being designed to have a more detailed pattern, so as to boost the instructing function.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A light-guiding plate, comprising:
a light-guiding substrate having a first surface and a second surface;
a first shielding layer disposed on the first surface and comprising a first light-transmitting portion; and
a second shielding layer disposed on the second surface and comprising a second light-transmitting portion;
wherein light emitted from a light source passes through the first light-transmitting portion, the light-guiding substrate and the second light-transmitting portion, wherein light-halo phenomenon on the light-guiding substrate is alleviated.

2. The light-guiding plate of claim 1, wherein a projection of the second light-transmitting portion upon the second surface overlaps a projection of the first light-transmitting portion upon the second surface.

3. The light-guiding plate of claim 1, further comprising a background layer disposed on the second shielding layer.

4. The light-guiding plate of claim 1, further comprising a transparent protecting layer disposed on the second shielding layer.

5. The light-guiding plate of claim 4, further comprising a background layer disposed between the transparent protecting layer and the second shielding layer.

6. The light-guiding plate of claim 4, wherein the transparent protecting layer is a transparent plastic sheet, and the second shielding layer is formed on the transparent plastic sheet.

7. The light-guiding plate of claim 6, further comprising an adhering layer for attaching the second shielding layer onto the second surface.

8. A method of manufacturing a light-guiding plate, comprising steps of:
preparing a light-guiding substrate with a first surface and a second surface opposite to the first surface;
forming a first shielding layer on the first surface, the first shielding layer comprising a first light-transmitting portion; and
forming a second shielding layer on the second surface, the second shielding layer comprising a second light-transmitting portion;
wherein light emitted from a light source is capable of passing through the first light-transmitting portion, the light-guiding substrate and the second light-transmitting portion.

9. The method of claim 8, further comprising a step of:
forming a background layer on the second shielding layer.

10. The method of claim 8, further comprising a step of:
forming a transparent protecting layer on the second shielding layer.

11. The method of claim 10, before forming the second shielding layer on the second surface further comprising a step of:
forming a background layer on the second shielding layer.

12. The method of claim 8, the step of forming the second shielding layer on the second surface comprising steps of:
forming the second shielding layer on a transparent plastic sheet;
forming an adhering layer on the second shielding layer; and
attaching the second shielding layer onto the second surface by the adhering layer.

13. The method of claim 12, the step of forming the second shielding layer on the transparent plastic sheet comprising steps of:
forming a background layer on the transparent plastic sheet; and
forming the second shielding layer on the background layer.

14. The method of claim 8, wherein the second light-transmitting portion faces the first light-transmitting portion.
